(19) United States
(12) Patent Application Publication
(10) Pub. No.: US 2015/0028168 A1
(43) Pub. Date: Jan. 29, 2015

(54) Multi-Conduit Coiled Tubing Assembly

(71) Applicant: CJS Production Technologies Inc., Calgary (CA)

(72) Inventor: Collin Rickey Morris, Calgary (CA)

(21) Appl. No.: 14/384,941

(22) PCT Filed: Mar. 5, 2013
(86) PCT No.: PCT/CA2013/050163

§ 371 Date: Sep. 12, 2014

Related U.S. Application Data
(60) Provisional application No. 61/611,101, filed on Mar. 15, 2012.

(51) Int. Cl. E21B 17/04; E21B 17/20; F16L 9/19; F16B 7/04; F16L 3/22; F16L 3/237; E21B 17/18; E21B 19/22

(52) U.S. Cl. CPC E21B 17/04; E21B 17/18; E21B 17/203; E21B 19/22; F16B 7/0433; F16L 3/22; F16L 3/237; F16L 9/19
USPC 248/68.1; 248/75; 403/188

(57) ABSTRACT

A coiled tubing assembly for use in a wellbore includes at least two continuous coiled tubing members which are joined by clamp assemblies at longitudinally spaced positions such that the tubing members are adapted to be collectively spoolable on a common drum. Each clamp assembly has a central portion spanning between the spaced apart coiled tubing members and clamping portions joined to the central portion to extend about the tubing members respectively. Each clamping portion is maintained in an elastically stretched state in a circumferential direction about the respective tubing member such that the internal circumference of the clamping portion is arranged to be elastically reduced about the respective tubing member when the tubing member stretches longitudinally in use within a wellbore.

### FIELD OF THE INVENTION

The present invention relates to a coiled tubing assembly including two or more independent, continuous tubing members connected at intervals by clamping members such that the tubing members extend alongside one another such that the strings can be simultaneously spooled and/or conveyed relative to a wellbore.

### BACKGROUND

Currently, and in the past, multi-conduit tubulars consisted of either concentric conduits with one inside the other, or integrally joined conduits aligned on the same horizontal plane and covered in an overall jacket of plastic to provide a unitary assembly. One type of integrally joined conduits is available under the trademark name Flatpak™. These items have several inherent limitations in some applications. For example, concentric coil is expensive to manufacture, and difficult to handle. FlatPak™ has temperature limitations due to the external jacket limits and may see premature wear on its external jacket in extreme wellbore conditions and due to equipment problems.

These previous designs were designed to provide methods of deploying and extracting multiple tubular for a variety of purposes, including service and completion work, without the need to hard connect or weld the conduits together. Welding the conduits together is not desirable because the heat affected areas of the continuous tubular do not cycle repeatedly or predictably as the original tubing members are designed for, nor do the heat affected areas resist corrosion as the original tubing members are designed to do.

As in all multiple tubular designs, it is imperative that the tubing members are connected in such a manner that when one tubular wants to move, the other tubular must move, or resist that movement equally, resulting in a product that moves together, even though it consists of many parts. This is especially important when using multiple sizes, and grades of continuous tubing members, because when you continuously deploy these products, the individual tubes will want to stretch, expand, contract, and helix at different rates, and under different conditions. This is why welding the tubes along their vertical line is not recommended, as welding various types of metals together is very tricky. Furthermore, cycling them would become very unpredictable, as the stresses would want to break them apart.

Using conventionally available clamps designed to clamp tubing members together also has inherent flaws. Typically when installed on a continuous coiled tubing member, the clamps are able to slide up and down the coil as they are not directly attached to the coil, and the coil can be slightly undersized at times from the manufacturer, or it can see reduced O.D. from stretch, working (cycling), or from temperature changes. Whenever a size change occurs, the clamps could slip, resulting in large sections of the overall package with no clamps at all, allowing the individual strings to “bow” or “flex” at will, and possibly resulting in a large number of clamps all stacked up in one spot. Known clamp designs are also generally unable to be spooled and thus are required to be installed as the tubing is injected into the wellbore.

U.S. Pat. No. 5,379,836 by Jordan discloses a clamp for use with a well tubular, and more particularly to a clamp for joining auxiliary electrical lines alongside a wellbore tubing member. The clamp relies on being clamped overtop of joint in discontinuous jointed tubing in order to prevent sliding misplacement of the clamp along tubing member. Without the interlocking connection of the clamp body about axially opposed ends of an enlarged connection in the jointed tubing, the clamp design is not suited to remaining fixed in position along the tubing member and thus is unsuitable for use with continuous coiled tubing members. Furthermore, the clamp cannot be spooled as it must be installed on the jointed tubing as the tubing is joined prior to insertion into a wellbore.

### SUMMARY OF THE INVENTION

According to one aspect of the present invention there is provided a coiled tubing assembly arranged for use in a wellbore, the tubing assembly comprising:

at least two continuous coiled tubing members, each defining a respective conduit extending in a longitudinal direction and arranged to receive wellbore fluids longitudinally therethrough; and

a plurality clamp assemblies connecting the tubing members to one another at respective clamping locations spaced apart from one another in the longitudinal direction such that:
the tubing members extend alongside one another in a parallel configuration; and
the tubing members and the clamp assemblies thereon are adapted to be collectively spoolable on a common spooling member.

Preferably each clamp assembly comprises at least one clamping body having clamping portions extending about the tubing members respectively, each clamping portion being formed of a spring or elastically deformable material having an internal radius or circumference in a relaxed state which is less than an outer radius or circumference of the respective tubing member such that the clamping portions are elastically stretched and tensioned about the respective tubing members. Furthermore, the clamping portions of each clamping body are preferably maintained in the elastically deformed and stretched state about the respective tubing members such that the internal circumference of each clamping portion is arranged to be elastically reduced about the respective tubing member when the tubing member stretches longitudinally in use within a wellbore. The clamping portions thus remain tightly gripping about the tubing members to remain fixed in the longitudinal direction of the tubing members even as the tubing members are stretched and reduced in circumference in use.

The tubing assembly according to the present invention addresses the need to connect tubing members with a metal medium without the need to weld onto the tubing members. More particularly, the tubing assembly is preferably an all metal multi-conduit consisting of two or more independent continuous coiled tubing strings, connected at intervals with specially designed clamps that allow for the individual tubulars to be continuously deployed and extracted into and out of well bores as one cohesive unit. Accordingly a user can simultaneously inject fluids/gases down one or more conduits and recover fluids/gases via other conduits without the need for any significant welding, or otherwise using heat treatments to weld the tubulars together so as to avoid changing the metallic structure of the tubulars.

When each clamp assembly comprises a clamping body having a central portion spanning between the coiled tubing members and clamping portions formed integrally with the central portion and extending in a circumferential direction about the tubing members respectively, preferably the central portion and the clamping portions of each clamping body are integrally formed with one another of elastically deformable material, for example a spring material such as spring steel.

Preferably the tubing members are independent and spaced apart from one another so as to be connected to one another only through the clamp assemblies. The tubing members in the illustrated embodiment are identical in diameter, though different sizes of tubing members can be joined to one another in further embodiments.

According to a preferred embodiment each clamp assembly comprises a single integral clamping body having a central portion spanning between the coiled tubing members and a pair of clamping portions formed integrally and seamless with the central portion at respective inner ends and extending in a circumferential direction about the tubing members respectively to respective outer ends joined to the central portion. The outer ends of each clamping body can be joined to the central portion of the clamping body by a weld.

Each clamping portion may further include two chamfered end portions at longitudinally opposed ends of the clamping portion in which an inner circumference of the clamping portion is increased towards the end of the clamping portion. The chamfered edge removes the internal sharp corners at the ends of the clamping portions to minimize wear on the tubing members during repeated spooling.

Preferably only one clamping portion is additionally secured to the respective tubing member by a weld while the other clamping portion remains secured only by relative friction imposed by the clamping portion extending about the tubing member under tension. When each clamping assembly is welded directly to only one tubing member, preferably it is welded to a tubing member which is different from the tubing member that each adjacent clamping assembly is welded to in the longitudinal direction of the tubing members.

According to an alternative embodiment, each clamp assembly may comprise two clamping bodies mounted on diametrically opposing sides of the tubing members. The two clamping bodies may be identical in configuration to one another. Each clamping body in this instance preferably has clamping portions extending about the tubing members respectively in which the clamping portions of the clamping bodies overlap and interlock one another in a circumferential direction about the respective tubing members. The central portions of the two clamping bodies are preferably connected to one another by welding. In the illustrated embodiment, each clamping portion extends in a circumferential direction more than 180 degrees about the respective tubing member.

When each clamp assembly comprises two clamping bodies with each clamping body comprising a central portion between the coiled tubing members and clamping portions extending from the central portion in a circumferential direction about the tubing members respectively and the central portions of the two clamping bodies being joined with one another, preferably the clamping portions overlap one another in the circumferential direction by at least 40 degrees. In this instance, each clamping portion extends from the central portion more than 200 degrees about the respective tubing member.

According to a further aspect of the present invention there is provided a method of preparing a coiled tubing assembly for use in a wellbore, the method comprising:

providing at least two independent, continuous coiled tubing members, each defining a respective conduit extending in a longitudinal direction so as to be arranged to receive wellbore fluids longitudinally therethrough;

providing a plurality clamp assemblies connecting the tubing members to one another at respective clamping locations spaced apart from one another in the longitudinal direction such that the tubing members extend alongside one another in a parallel configuration; and

providing a common drum upon which said at least two independent, continuous coiled tubing members and the clamp assemblies thereon are collectively spooled.

Preferably each clamp assembly comprises a clamping body having clamping portions which are elastically deformed under tension about the respective tubing members and maintained in the elastically deformed state about the tubing members respectively such that the internal circumference of each clamping portion is arranged to be elastically reduced about the respective tubing member when the tubing member stretches longitudinally in use in a wellbore.

The method preferably further includes: i) drawing the tubing members from respective individual drums; ii) coupling the tubing members in parallel and spaced apart configuration by sequentially mounting the clamp assemblies at the respective clamp locations as the tubing members are drawn from the respective individual drums, and iii) collectively spooling the coupled tubing members on a common drum as the clamp assemblies are sequentially mounted at the respective clamp locations.

When each clamp assembly comprises a single integral clamping body having a central portion spanning between the coiled tubing members and a pair of clamping portions formed integrally and seamless with the central portion at respective inner ends and extending outwardly to respective outer ends, preferably the method includes: i) pressing the outer ends of each clamping body towards the central portion such that each clamping portion extends in an elastically stretched state in a circumferential direction about the tubing members respectively; and ii) joining the outer ends of each clamping body to the central portion such that the clamping portions are under tension about the respective tubing members. The outer ends of each clamping body may be joined to the central portion of the clamping body by welding.

Alternatively when each clamp assembly includes two clamping bodies comprising a central portion spanning between the coiled tubing members and clamping portions extending from the central portion in a circumferential direction about the tubing members respectively, the method preferably includes pressing the two clamping bodies onto opposed sides of the tubing members such that the clamping portions are under tension about the respective tubing members. Preferably the central portions of the two clamping bodies are joined by welding while the clamping portions are under tension. In some embodiments the clamping portions of one clamping body are joined to the clamping portions of the other clamping body by welding while the central portions of the two clamping bodies remain spaced apart. In this instance, the central portions of the two clamping bodies are preferably subsequently pressed together and joined by welding.

Some embodiments of the invention will now be described in conjunction with the accompanying drawings in which:

### BRIEF DESCRIPTION OF THE DRAWINGS

FIG. 1 is an elevational view of a section of the tubing assembly;

FIG. 2 is a perspective view of one of the clamping assemblies according to the first embodiment of the present invention, shown clamped on a section of the tubing members;

FIG. 3 is another perspective view of one of the clamping assemblies according to the first embodiment of FIG. 2 shown clamped on a section of the tubing members;

FIG. 4 is a perspective view of one of the clamping bodies of a clamping assembly according to the first embodiment of FIG. 2;

FIG. 5 is an end view of one of the clamping assemblies about a section of the tubing members according to the first embodiment of FIG. 2;

FIG. 6 is a plan view of a sheet metal blank used to form one of the clamping bodies according to the first embodiment of FIG. 2;

FIG. 7 is a perspective view of a pair of dies of a die press for forming the sheet metal blank of FIG. 6 into one of the clamping bodies;

FIG. 8 is a schematic representation of a press including electrodes for welding the two clamping bodies together at the central portions once the two clamping bodies are pressed onto the tubing members according to the first embodiment of FIG. 2;

FIG. 9 is a schematic representation of the assembly process for forming the tubing assembly according to either embodiment;

FIG. 10 is an end view according to the second embodiment of the present invention of one of the clamping assemblies about a section of the tubing members;

FIG. 11 is a sectional view along the line 11-11 of FIG. 10;

FIG. 12 is a perspective view one of the clamping assemblies according to the second embodiment of FIG. 10;

FIG. 13 is a perspective view of a third embodiment of the clamping assembly;

FIG. 14 is an end view of the third embodiment of the clamping assembly in an intermediate step in the forming process where it is ready to be clamped onto the tubing members;

FIG. 15 is an end view of the clamping assembly according to the third embodiment in a fully formed step just prior to tensioning the clamping portions about the respective tubing members; and

FIG. 16 is an end view of a flat blank of material prior to forming into a clamping body according to the third embodiment.

In the drawings like characters of reference indicate corresponding parts in the different figures.

### DETAILED DESCRIPTION

Referring to the accompanying figures there is illustrated a multi-conduit coiled tubing assembly generally indicated by reference numeral 10. The assembly 10 comprises a plurality of independent, continuous coiled tubing members 12 which are joined together in substantially parallel and fixed relation relative to one another. Typically the coiled tubing members are all metal tubing members which are spoolable and arranged for use in various hydrocarbon wellbore operations.

In the illustrated embodiments, the assembly comprises two tubing members; however, more tubing members may be joined together to form the tubing assembly in further embodiments. Although various embodiments are described and illustrated herein, the common features between the various embodiments will first be described.

In each instance, each coiled tubing member 12 defines its own respective conduit extending in a longitudinal direction therethrough for conveying wellbore fluids. The fluids may include produced fluids extending upwardly therethrough from the surrounding wellbore to the surface, or various injected fluids to aid in production, or hydraulic fluid which is injected downhole for driving a downhole pump and the like.

The conduits are joined with one another so as to be parallel and spaced apart with the central longitudinal axis of each conduit lying in a common plane with the other axes such that the conduits extend alongside one another along the full length thereof. The conduits are joined to one another by a plurality of clamp assemblies 14 fixed across all of the tubing members at respective clamping locations which are spaced apart from one another in the longitudinal direction, for example in the range of 5-10 feet, and more preferably near 8 feet.

The clamping assemblies span in the longitudinal direction of the tubing members a short distance, for example less than 6 inches and more preferably near to or less than 2 inches in length such that the clamping assemblies do not interfere with spooling of the assembled coil tubing assembly. The clamping assemblies are arranged to be installed along respective continuous sections of the tubing members at any location along the length thereof. The clamping assemblies are typically undersized relative to the outer diameter of the tubing members such that the clamping assemblies are clamped under tension about the respective tubing assemblies to be frictionally retained in position along the tubing member.

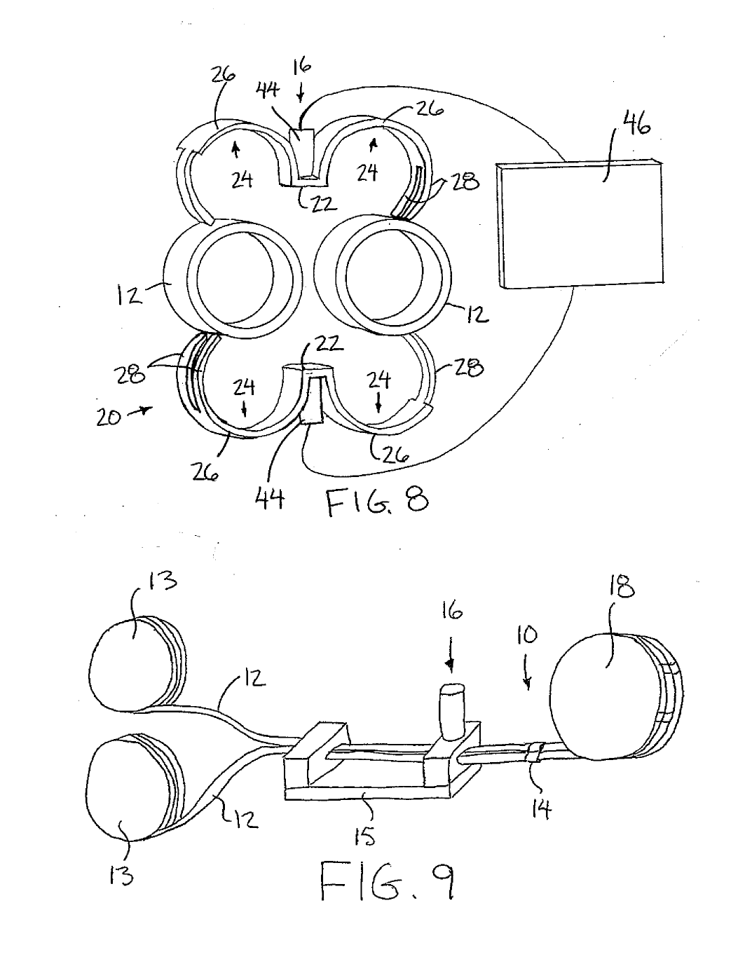

As shown in FIG. 9, the assembly 10 in all embodiments is typically manufactured by drawing each independent coiled tubing member 12 from its own respective drum 13. By connecting the ends of the tubing members, equal lengths of tubing can be drawn from each drum and passed through a suitable jig 15 in a parallel relationship. A pressing assembly 16 presses the clamp assemblies 14 onto the tubing members at a prescribed spacing determined by the jig.

As each clamping assembly is mounted in position, the tubing members are drawn through the jig by the prescribed spacing for installation of the next clamp assembly. The joined portion of the tubing members are then re-spooled onto a common take-up drum 18 as an assembled finished product. Once equal lengths of coiled tubing members 12 have been joined together and spooled onto the common drum 18, the assembled product is then ready for use in a wellbore by conveying the two joined tubing members into and out of the wellbore together as a single integral tubing assembly.

Each clamp assembly generally includes one or more clamping bodies 20 in which each clamping body has a central portion 22 for spanning between the two adjacent tubing members and two clamping portions 24 associated with the two tubing members respectively. Each clamping portion 24 is formed of a spring or elastically deformable material having an internal radius or circumference in a relaxed state which is less than an outer radius or circumference of the respective tubing member such that the clamping portions are elastically stretched and tensioned about the respective tubing members as they are mounted in position about the tubing members respectively using the pressing assembly 16 described above.

Once mounted in place on the tubing members, the clamping portions of each clamping body are maintained in the elastically deformed and stretched state about the respective tubing members. Accordingly when the tubing members are in use downhole in a wellbore and are subjected to stretching so that the diameter is reduced, the internal circumference of each clamping portion is elastically reduced about the respective tubing member as the diameter of the tubing member is reduced, thus maintaining the clamping assemblies gripped about the tubing members even when the tubing members stretch longitudinally.

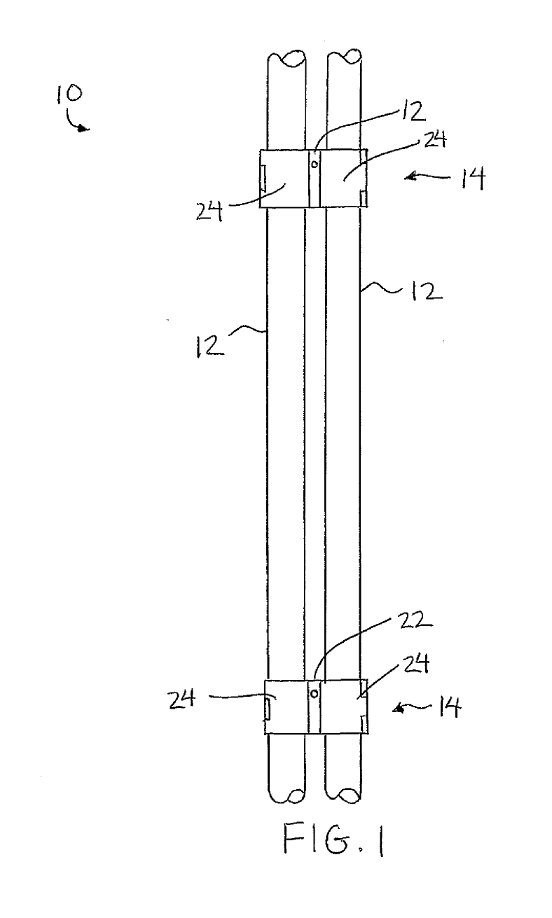

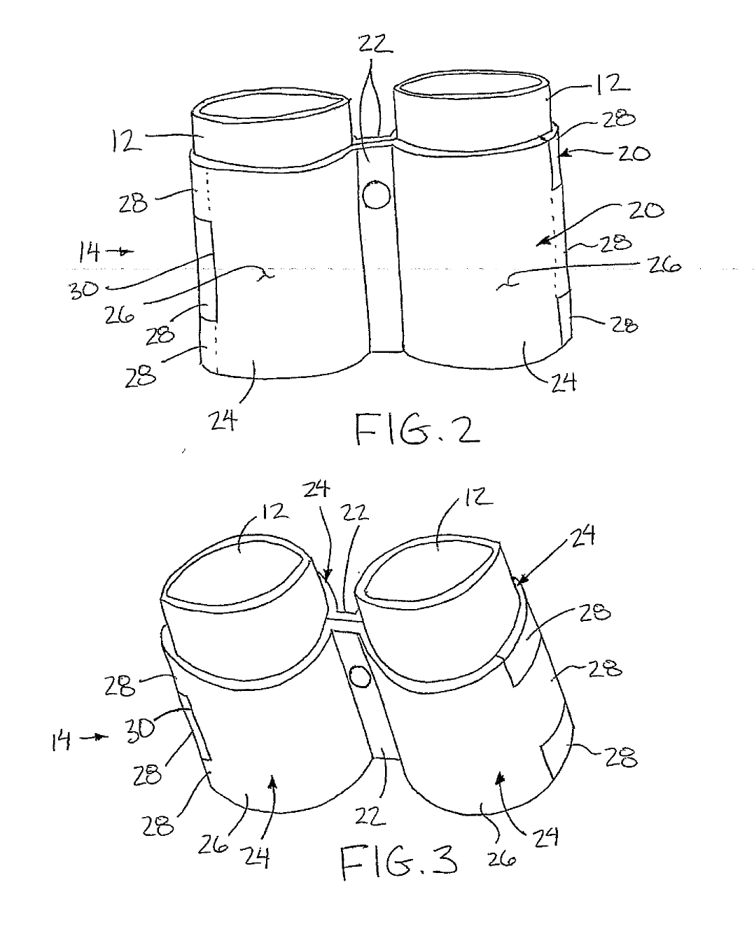

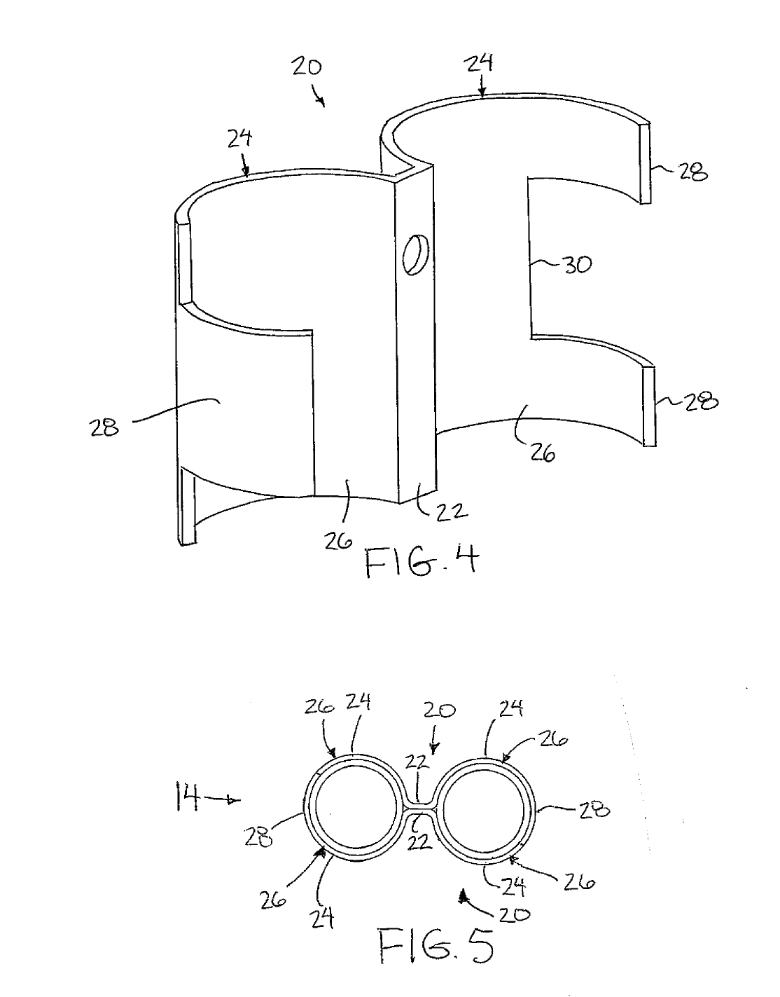

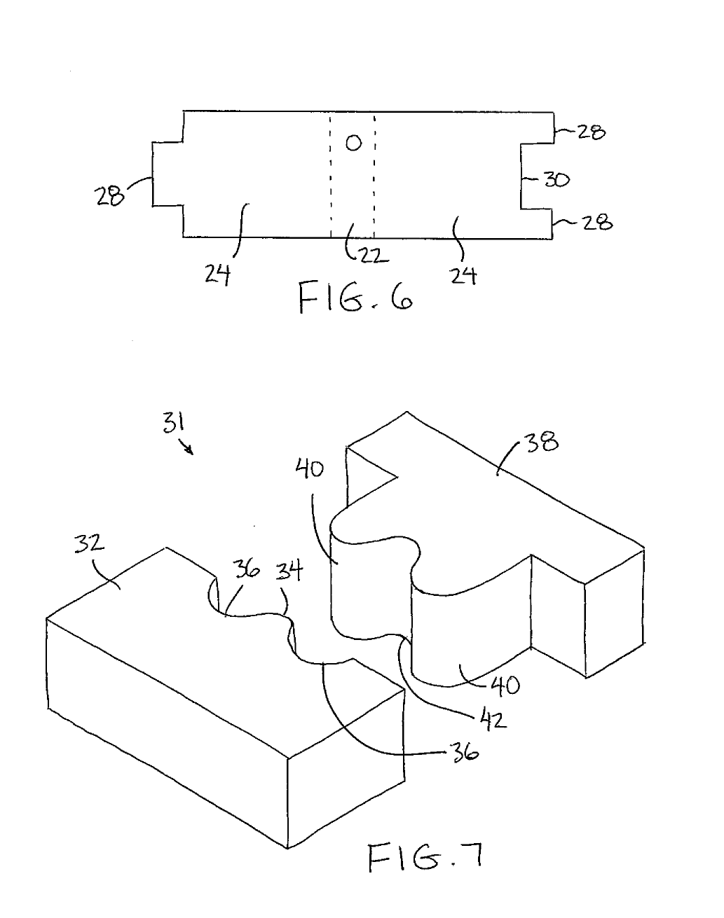

Turning now more particularly to the first embodiment of FIGS. 1 through 8, in this instance each clamp assembly comprises two clamp bodies 20, clamped onto opposing sides of the common plane locating the longitudinal axes of the tubing members therein. The two clamping bodies thus clamp each tubing member on diametrically opposed sides thereof.

Each clamping body includes a central portion 22 for spanning between the two adjacent tubing members in the illustrated embodiment and two clamping portions 24 associated with the two tubing members respectively. Each clamping portion 24 thus extends about a respective tubing member together with a respective clamping portion of the other clamping body.

Each clamping portion spans from an inner end joined to the central portion such that the clamping portions are joined along opposing sides of the central portion, to an outer end opposite from the central member so that the clamping portion extends generally in a circumferential direction about the respective tubing member.

The clamping portions of the clamping assemblies are suitably sized such that an inner diameter or inner radius of curvature of each clamping portion is smaller in a relaxed state than the corresponding outer diameter or outer radius of the tubing member about which it extends. The clamping portions are formed integrally with the central portion of a continuous, seamless and integral high strength steel which is sufficiently spring-like or elastic or resilient to allow some slight flexing to accommodate the larger outer diameter of the tubing member while remaining biased towards the relaxed state of smaller diameter.

Each clamping portion 24 includes a main body portion 26 spanning from the inner end in the circumferential direction towards the outer end while spanning the full height of the clamping assembly in the axial direction. Each clamping portion further includes at least one protruding portion 28 extending in the circumferential direction beyond the outer end of the main body portion 26 for overlapping the protruding portion of the corresponding clamping portion 24 of the other clamping body.

Within each clamping body, the clamping portion at one end includes two protruding portions 28 at axially opposed top and bottom ends to define a recess 30 therebetween. The outer end of the other clamping portion within each clamping body includes only a single protruding portion 28 which is centered in the axial direction so as to be aligned with and substantially fill the recess 30 formed between the protruding portions 28 of a mating clamping body 20. When the two clamping bodies 20 are identical in configuration, the first clamping portion of one clamping body thus defines the single protruding portion received in the recess 30 of the second clamping portion of the other clamping body. The two clamping bodies thus define two clamping portions in interlocking configuration about each tubing member. The interlocking configuration is defined by the interlocking protruding portions 28 positioned in sequence adjacent one another in the axial direction but arranged to overlap one another in the circumferential direction. The length of the protruding portions 28 are typically arranged such that the outer end of each protruding portion substantially meets the outer end of the main body portion 26 of the mating clamping portion.

When the two tubing members are positioned such that their longitudinal axes lie in a common plane, the central portions are typically arranged to span between the two tubing members at spaced apart locations on opposing sides of the common plane while the clamping portions extend greater than 180 degrees in the circumferential direction to cross over the common plane at the outer ends. By joining the clamping portions to the respective central portions at an exterior angle of slightly greater than 90 degrees, once the clamping portions are secured on to the respective tubing members, the central portions of the two opposed clamping bodies of each clamp assembly are typically spaced apart but in close proximity to one another. Accordingly subsequent pressing of the two central portions together for joining by welding or by suitable fastening applies additional tension of the clamping portions about the respective tubing members to ensure that the clamping assemblies are fixed in the axial direction along the respective continuous sections of the tubing members where they are clamped.

If, for example, each of the clamping portions has a suitable length in the circumferential direction to span 200 degrees about the respective tubing member, each clamping portion would extend 20 degrees beyond the common plane such that the two clamping portions about each tubing member would overlap one another by approximately 40 degrees. More particularly in the illustrated embodiment, when the main portions extend in the circumferential direction in the range of 145 degrees with the protruding portions extending an additional 90 degrees beyond that relative to the respective joined central portions, each protruding portion would protrude 45 degrees beyond the common plane to the opposing side of the tubing members such that the two protruding portions would overlap one another in the circumferential direction in the range of 90 degrees.

Typically, the clamp assemblies are formed in different sizes according to the size of the tubular members. In each instance, each clamping body is formed from a respective flat blank sheet of steel including a single protruding portion at one end and two protruding portions at the opposing end defining the recess 30 therebetween for receiving the single protruding portion of another clamping body of like configuration.

The flat steel sheet is formed into the respective clamping bodies by a suitable die press 31 in which a first die 32 includes a first central lobe 34 for forming the central portion and two recesses 36 for receiving the respective clamping portions therein. The second die 38 includes two lobes 40 for pressing the steel into the two recesses of the other die and a recess 42 therebetween for receiving the single lobe forming the central portion on the other die.

The dies of the press 31 form the blank of steel such that the internal diameter or radius of the clamping portions in the relaxed state is smaller than the outer diameter or radius of the respective tubing members even when the tubing members are suspended in a wellbore in a stretched state such that the clamping portions retain their tension about the tubing members to frictionally fix the clamping assemblies in the axial direction under various conditions of the tubing member even if the outer diameter of the tubing member is reduced by stretching for example. When it is desirable for the clamping portions to extend more than 180 degrees about the respective tubing members, additional roll forming or progressive pressing operations may be used to form the desired degree of curvature of the clamping portions.

The press assembly 16 is typically arranged to position the two clamping bodies of each clamp assembly on opposing sides of the common plane with the central portions aligned with the gap between the two tubing members. Electrodes 44 are integrated into opposing joining presses of the press assembly 16 aligned with the central portions such that the central portions can be welded together by a suitable welder 46 connected to the electrodes 44 once the press assembly has pressed the two central portions together from opposing sides of the common plane. The protruding portions of the two clamping portions have sufficient resilience to be flexed outwardly for accommodating the respective tubing members therein as the two clamping bodies are pressed together from the opposing sides while having sufficient strength to return towards the relaxed state to apply clamping tension about each of the tubing members without additional fastening or securing being required.

In some instances, where interlocking of protruding portions is not possible, the clamping portions are arranged to span in the circumferential direction to respective outer ends in the range of slightly less than 180 degrees. The two clamping bodies are pressed together in this instance into an intermediate position where the outer ends of the two clamping portions about each tubing member abut one another but the central portions of the clamping bodies remain slightly spaced apart. The outer ends of the clamping portions are welded together such that the two clamping portions extend substantially about the full-perimeter of the respective tubing member except for the small space between the two central portions. The central portions are then pressed together to apply tension to the clamping portions secured about each tubing member. One the central portions are welded together in a pressed condition, the stress or grip of the clamping portions onto the respective tubing members is maintained.

As described above according to the first embodiment, the clamps are a two piece, side interlocking, press-on design. They are placed on either side of the coil in such a manner that when pressed together onto the coils, the sides interlock, or are welded together if interlocking is not viable. The clamps are slightly undersized in the radial portion, so that they must be pressed onto the intended coils. The interlocking tabs (if present) extend beyond the 90 degree, or mid portion of the underlying pipe, so that when the clamps are pressed onto the coil, the tabs extend around the mid portion of the pipe, and because they are undersized, they grip the underlying coils. The two clamps are then fused or welded in the center to each other, not to the coils. If interlocking was not possible, the sides of the clamps are welded together, leaving a small gap between the center of the clamps. The clamps are then pressed together in the center which produces a gripping effect on the individual tubulars. Once the center portions of the clamp have been pressed together, they are welded to each other, thus maintaining the stress or grip on the tubular.

These clamps are pressed on as identified above, and welded/fused together while the pressure from the pressing system is still on them. This ensures that the clamps retain their springy attributes, and are able to collapse into the underlying coils if the underlying coils shrink due to stretch, cycling, wear, temperature, or otherwise, and by ensuring that grip, the clamps will not have the ability to move/slide out of position.

Also as noted above, manufacturing of the tubing assembly 10 generally includes the following steps:

1) The ends of two or more continuous tubes are connected together to ensure consistent movement when being drawn off of their spools.

2) The two or more continuous tubes are then drawn off of their individual drums horizontally, through a guide, or jig that ensures that the tubular are as straight as possible, and of a like length in-between the clamps. The end is then inserted into a take up drum that will re-spool the assembled product as it is completed.

3) At a predetermined length, (5′, 7′, 8′, 10′, etc.) the clamping assembly is installed using pressure to conform the clamp to the O.D. One clamp is placed on top of the horizontally arranged tubes, and one clamp is placed directly below the first clamp, in its opposing interlocking configuration.

4) The clamps are then pressed onto the coils in such a manner that the interlocking sides match and interlock, by means of a pressing instrument. If no interlocking sides are present, the flat edges are welded together once the clamp is pressed on.

5) While the pressure is still on the clamps, the center portions of the clamps are fused or welded together, forming one clamp which encompasses the underlying coils.

6) The pressing instrument is then relaxed, and the assembled tubing members 12 are advanced the required amount to the next assembly. This process continues, and the finished product is spooled onto the take up spool.

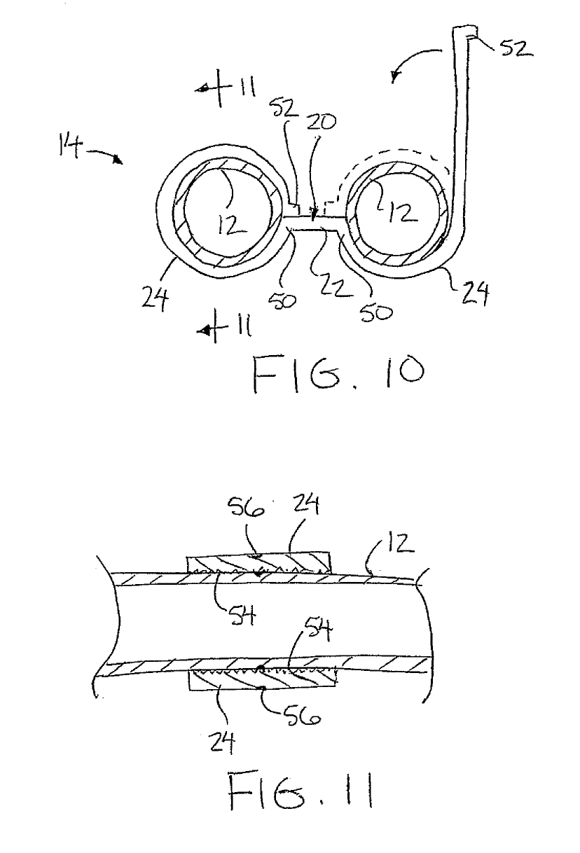

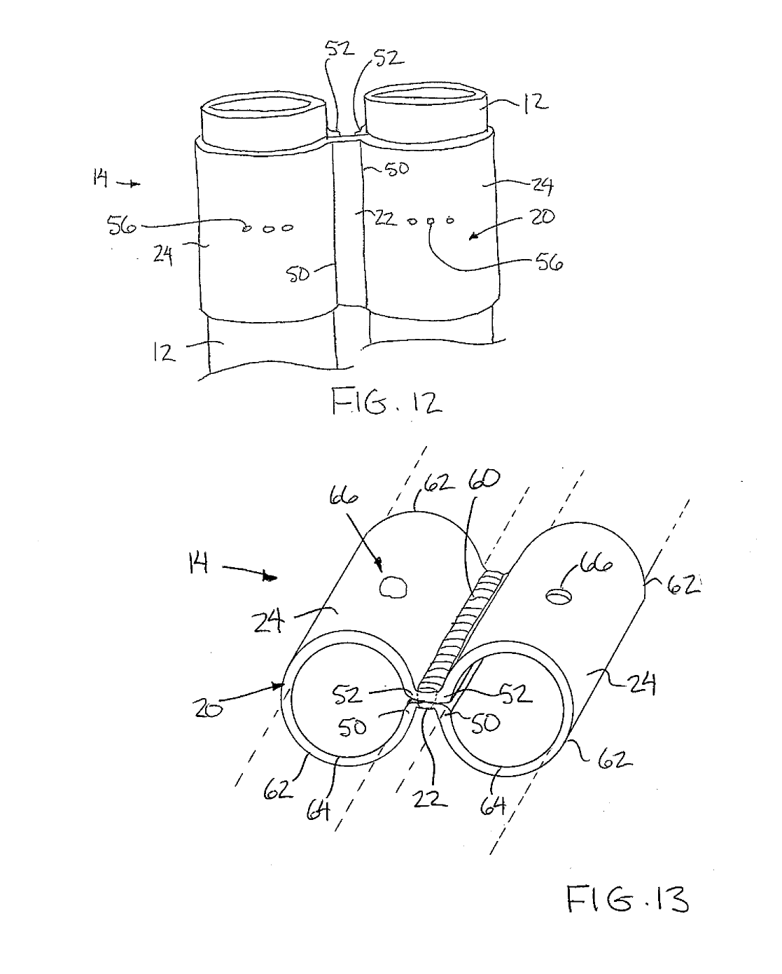

Turning now to the second and third embodiments of FIGS. 10 through 16, each clamping assembly 14 in this instance comprises a single clamping body 20 including a central portion 22 which spans between the spaced apart tubing members 12 as described above, and a clamping portion 24 extending circumferentially about each tubing member.

The central portion 22 is a flat sheet portion which spans between the two adjacent tubing members in the illustrated embodiment so as to lie in a common plane with the central longitudinal axes of the tubing members 14. The clamping portions 24 span in opposing directions from respective inner ends 50 joined along opposing sides of the central portion to respective outer ends 52 opposite from the central member so that the clamping portions extend generally in a circumferential direction about the respective tubing members.

Length of the clamping body in the longitudinal direction of the tubing members including the central portion and the clamping portions is typically less than 6 inches and preferably nearer to or less than 2 inches overall so as not to interfere with coiling of the assembled coiled tubing assembly 10 onto a common drum 18 as described above.

The clamping portions 24 of the clamping assemblies are sized such that their inner circumference defined by their length in the circumferential direction between the inner ends 50 and the outer ends 52 are less than the circumference of the respective tubing members 14 received therein. During the assembly process, the clamping portions are stretched in the circumferential direction of the tubing members using a pressing assembly 16 as described above such that the outer ends 52 can be subsequently welded to the central portion 22 of the clamping body in an elastically deformed and stretched state of the clamping portions. This results in an inner circumference, or an inner diameter, or an inner radius of curvature of each clamping portion being smaller in a relaxed state than the corresponding outer circumference, outer diameter or outer radius of the tubing member about which it extends in the assembled state.

The clamping portions are formed integrally with the central portion of a continuous, seamless and integral high strength steel which is sufficiently spring-like or elastic or resilient to allow some slight flexing or stretching within an elastic range to accommodate the larger outer diameter of the tubing member while remaining biased towards the relaxed state of smaller diameter to provide securing clamping about the tubing members. In this manner, even when the tubing members are axially or longitudinally stretched in downhole use, the clamping portions remain securely clamped under tension about the respective tubing member to prevent slippage of the clamping assemblies in the axial direction along the tubing members 14.

In either of the embodiments of FIG. 10 or 13, the tubing assembly is assembled by drawing two coiled tubing members 12 from respective spools 13 to be guided through a jig 15 where clamping assemblies 14 can be sequentially applied to form the only connection between the tubing members as described above. Typically the clamping bodies are partially pre-formed using various dies with corresponding lobes as described above and various steps of pressing operations to cold work and plastically deform the blanks into clamping bodies. Each clamping assembly is thus formed from a cut length of stock plate material to define one clamping body by bending the clamping portions relative to the central portion and then forming the clamping portions in stages into their respective annular shape about the respective tubing members using the jigs.

At the intermediate stage shown in FIGS. 10 and 14, the partially pre-formed clamping bodies include the central portion and partial clamping portions which extend only partway in the circumferential direction of the tubing members to allow placement onto the tubing members. The pre-formed clamping bodies also include lips 58 in the form of bent edge portions along the full longitudinal length of the clamping body at the outer ends 52. The bent end portions protrude at 90 degrees to the remainder of the clamping portion so as to be oriented to project radially outward from the circumferential direction of the clamping portions in the assembled position.

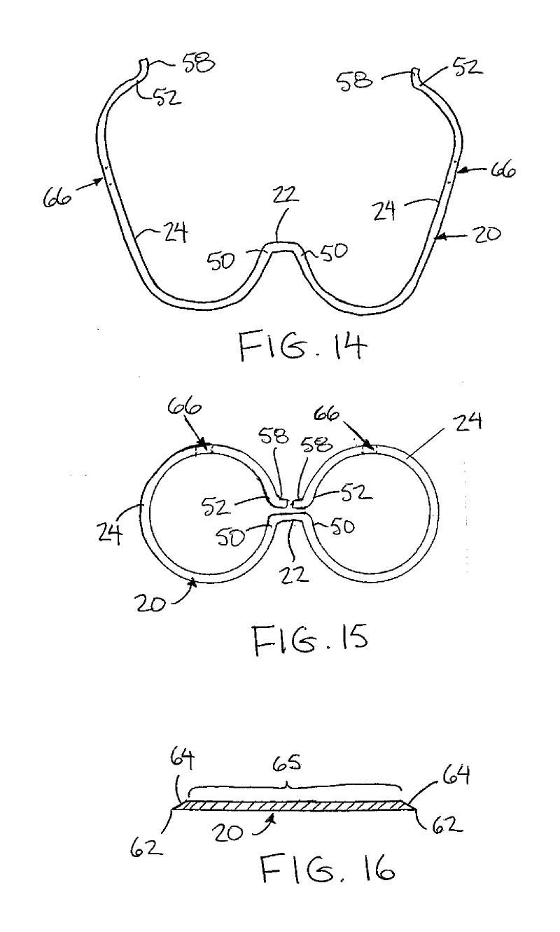

Upon placement of each clamping body on the respective tubing member, the clamping members are bent to follow the circumferential direction from the inner end 50 to the outer end 52 thereof. The length of the clamping portions about tubular members is arranged so that a gap remains in circumferential direction between inner ends joined to the central portion and outer ends as shown in FIG. 15. The lips 58 at the outer ends are also spaced from central portion at the intermediate manufacturing step prior to application of tension by the pressing assembly.

The pressing assembly 16 engages the lips 58 and presses the lips 58 at the outer ends towards the central portion such that clamping portions are elastically stretched under tension in the circumferential direction about the tubing members respectively. More particularly the pressing assembly is arranged to grip the clamping portions and pull the outer ends 52 back towards the central portion 20 with sufficient tension to elastically deform the clamping portions and permit the outer ends 52 to be joined to the central portion even when the clamping portions are undersized relative to the respective tubing members.

While maintaining pressure with the pressing assembly 16, the outer ends 52 are joined to the central portion and the respective inner ends 50 by a weld 60 using electrodes incorporated with the pressing assembly as described above. This serves to maintain the clamping portions in the elastically stretched state about the respective tubing members. The weld is a full penetration seam weld between the outer ends and the central portion which spans the full length in the longitudinal direction of the tubing members between longitudinally opposed ends 62 of the clamping body.

As described in regard to the embodiments of both FIGS. 10 and 13, the clamping assembly starts as one piece, and is pressed using specialized equipment onto the coiled tubing members. The clamping body is built at a specific length so that when it is applied to the coiled tubing members, the lips 58 do not quite touch when applied to the circumference of the coil. The lips are then pressed down to make contact with the metal of the central portion below, causing the clamp to grab the coiled tubing members due to its elastic nature. The lips are then welded back to the central portion of the clamp body while it is stressed in the jig. Accordingly, the clamp remains in its elastic state when the hydraulic pressing assembly releases. This grabbing effect is important so that when the tubing is hung vertically and stretches so that the outer diameter reduces, the inner diameter of the clamping portions are similarly reduced. The elastic nature of the clamp allows the clamp to shrink and expand with the outer diameter of the tubing due to internal pressures, and vertical hang stretch.

Turning now more particularly to the embodiment of FIGS. 10 through 12, to further resist slippage of the clamping assemblies along the tubing members in use, each clamping assembly can be formed from a flat band of material having a textured inner surface which forms the inner surface of the clamping portions. More particularly the inner surface of each clamping portion 24 includes a plurality of teeth 54 in the form of protruding ridges having an apex spanning in the circumferential direction for biting into an outer surface of the tubing member when the clamping portions 24 are secured under tension about the tubing members respectively. The teeth may be formed by stamping or cold forming technique onto elongate flatbar or other stock material which is cut in lengths to form the clamping bodies.

To yet further secure each clamping assembly to the respective tubing members a dimpling tool may be pressed into the outer surface of each clamping portion at plural locations to form respective dimples 56. At each dimple 56, material of the clamping portion is pressed from the external pressure at the outer surface to protrude from the inner surface and be pressed into the outer surface of the tubing member surrounded by the clamping portion. Each dimple 56 results in a deformation where a portion of material forming the clamping portion protrudes inwardly into a corresponding mating deformation formed into the outer surface of the respective tubing member. Typically a plurality of dimples 56 are formed in each clamping portion at circumferentially spaced apart locations. In some instances, it may be desirable to join only one of the clamping portions of each clamping assembly to the respective tubing member by dimpling and to alternate which tubing member the clamping assembly is fixed to by dimpling along the length of the tubing members in the longitudinal direction.

Turning now more particularly to the embodiment of FIGS. 13 through 16, the two longitudinally opposed ends 62 of each clamping portion in this instance further includes a chamfered end portion 64 at the inner side thereof. Accordingly, the inner circumference of the clamping portion is gradually increased from the main body portion 65 of the clamping portions towards each end 62 of the clamping portion to minimize the sharpness of any internal corners engaging the exterior of the tubing members. This minimizes wear imposed on the tubing members by the clamping assemblies during repeated spooling of the assembled coiled tubing assembly.

To assist in longitudinally securing the clamping assemblies to the tubing members, a welding aperture 66 is provided in each clamping portion at a central location in the longitudinal direction of the tubing members. Each welding aperture is arranged to receive a fill of a weld material to form a spot weld between the clamping body and a respective tubing member. Typically only one clamping portion of each clamping assembly is welded to the respective tubing member. Furthermore, the clamping assemblies are welded to the tubing members in an alternating configuration along the length of the tubing members such that each clamping assembly is welded directly to only one tubing member which is different from the tubing member that each adjacent clamping assembly is welded to in the longitudinal direction of the tubing members. Accordingly, the spot welds are located in pre drilled holes, on one side only of each clamping assembly. The welds are staggered from one side to the next as clamps are sequentially applied, for example at 8 ft intervals, to allow some twisting movement at the clamp itself, otherwise when the clamps enter the injector head any twist would be forced back in a linear direction so as to cause the welded portion of the clamp to bend and angle undesirably.

In further embodiments, when coupling more than two tubing members parallel to one another with their central longitudinal axes in a common plane, each clamping assembly can comprise one or more clamping bodies 20; however in each instance, at least one clamping portion 24 is associated with each tubing member for clamping about the tubing member. The clamping portions are undersized or are pre-shaped and pre-stressed relative to the respective tubing members in each instance so as to result in an inner circumference, or an inner diameter, or an inner radius of curvature of each clamping portion being smaller in a relaxed state than the corresponding outer circumference, outer diameter or outer radius of the tubing member about which it extends in the assembled state.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A coiled tubing assembly arranged for use in a wellbore, the tubing assembly comprising:
at least two continuous coiled tubing members, each defining a respective conduit extending in a longitudinal direction and arranged to receive wellbore fluids longitudinally therethrough; and
a plurality clamp assemblies connecting the tubing members to one another at respective clamping locations spaced apart from one another in the longitudinal direction such that:
the tubing members extend alongside one another in a parallel configuration; and
the tubing members and the clamp assemblies thereon are adapted to be collectively spoolable on a common spooling member.

2. The assembly according to claim 1 wherein each clamp assembly comprises at least one clamping body having clamping portions extending about the tubing members respectively, each clamping portion being formed of an elastically deformable material having an internal circumference in a relaxed state which is less than an outer circumference of the respective tubing member in a relaxed state such that the clamping portions are under tension in the circumferential direction about the respective tubing members.

3. The assembly according to claim 2 wherein the clamping portions of each clamping body are maintained in an elastically deformed state about the tubing members respectively such that the internal circumference of each clamping portion is arranged to be elastically reduced about the respective tubing member when the tubing member stretches longitudinally.

4. The assembly according to any one of claims 1 through 3 wherein each clamp assembly comprises at least one clamping body having a central portion spanning between the coiled tubing members and clamping portions formed integrally with the central portion and extending in a circumferential direction about the tubing members respectively.

5. The assembly according to claim 4 wherein the central portion and the clamping portions of each clamping body are integrally formed with one another of elastically deformable material.

6. The assembly according to any one of claims 1 through 5 wherein the tubing members are independent and spaced apart from one another so as to be connected to one another only through the clamp assemblies.

7. The assembly according to any one of claims 1 through 6 wherein each clamp assembly comprises a single integral clamping body having a central portion spanning between the coiled tubing members and a pair of clamping portions formed integrally and seamless with the central portion at respective inner ends and extending in a circumferential direction about the tubing members respectively to respective outer ends joined to the central portion.

8. The assembly according to claim 7 wherein the outer ends of each clamping body are to the central portion of the clamping body by a weld.

9. The assembly according to any one of claims 1 through 8 wherein each clamp assembly comprises at least one clamping body having clamping portions extending about the tubing members respectively, each clamping portion comprising two chamfered end portions at longitudinally opposed ends of the clamping portion in which an inner circumference of the clamping portion is increased towards the end of the clamping portion.

10. The assembly according to any one of claims 1 through 9 wherein one clamping portion of each clamping assembly is welded to the respective tubing member.

11. The method according to claim 10 wherein only one clamping portion of each clamping assembly is welded to the respective tubing member such that each clamping assembly is welded directly to only one tubing member which is different from the tubing member that each adjacent clamping assembly is welded to in the longitudinal direction of the tubing members.

12. The assembly according to any one of claims 1 through 11 wherein the tubing members are identical in diameter relative to one another.

13. The assembly according to any one of claims 1 through 11 wherein each clamp assembly comprises clamping portions extending in a circumferential direction about respective ones of the tubing members, each clamping portion includes an inner surface having teeth formed thereon arranged for biting engagement with the respective tubing member.

14. The assembly according to any one of claims 1 through 12 wherein each clamp assembly comprises clamping portions extending in a circumferential direction about respective ones of the tubing members, each clamping portion including a deformation where a portion of material forming the clamping portion protrudes inwardly into a mating deformation in an outer surface of the respective tubing member.

15. The assembly according to claim 1 wherein each clamp assembly comprises two clamping bodies mounted on diametrically opposing sides of the tubing members.

16. The assembly according to claim 15 wherein each clamping body has clamping portions extending about the tubing members respectively, the clamping portions of the clamping bodies overlapping one another in a circumferential direction about the respective tubing members.

17. The assembly according to either one of claims 15 through 16 wherein each clamp assembly comprises two clamping bodies, each having a central portion spanning between the coiled tubing members and clamping portions formed integrally with the central portion and extending in a circumferential direction about the tubing members respectively, the central portions of the two clamping bodies being connected to one another.

18. The assembly according to any one of claims 15 through 17 wherein each clamping portion extends in a circumferential direction more than 180 degrees about the respective tubing member.

19. The assembly according to any one of claims 15 through 18 wherein:
each clamp assembly comprises two clamping bodies;
each clamping body comprises a central portion between the coiled tubing members and clamping portions extending from the central portion in a circumferential direction about the tubing members respectively;
the central portions of the two clamping bodies are joined with one another; and
the clamping portions overlap one another in the circumferential direction by at least 40 degrees.

20. A method of preparing a coiled tubing assembly for use in a wellbore, the method comprising:
providing at least two independent, continuous coiled tubing members, each defining a respective conduit extending in a longitudinal direction so as to be arranged to receive wellbore fluids longitudinally therethrough;
providing a plurality clamp assemblies connecting the tubing members to one another at respective clamping locations spaced apart from one another in the longitudinal direction such that the tubing members extend alongside one another in a parallel configuration; and
providing a common drum upon which said at least two independent, continuous coiled tubing members and the clamp assemblies thereon are collectively spooled.

21. The method according to claim 20 including:
drawing the tubing members from respective individual drums;
coupling the tubing members in parallel and spaced apart configuration by sequentially mounting the clamp assemblies at the respective clamp locations as the tubing members are drawn from the respective individual drums, and
collectively spooling the coupled tubing members on the common drum as the clamp assemblies are sequentially mounted at the respective clamp locations.

22. The method according to either one of claim 20 or 21 wherein each clamp assembly comprises a clamping body having clamping portions which are elastically deformed under tension about the respective tubing members.

23. The method according to claim 22 wherein the clamping portions of each clamping body are maintained in an elastically deformed state about the tubing members respectively such that the internal circumference of each clamping portion is arranged to be elastically reduced about the respective tubing member when the tubing member stretches longitudinally.

24. The method according to any one of claims 20 through 23 wherein each clamp assembly comprises at least one clamping body having a central portion spanning between the coiled tubing members and clamping portions formed integrally with the central portion and extending in a circumferential direction about the tubing members respectively.

25. The method according to claim 24 wherein the central portion and the clamping portions of each clamping body are integrally formed with one another of elastically deformable material.

26. The method according to any one of claims 20 through 25 further comprising:
providing each clamp assembly with a single integral clamping body comprising a central portion spanning between the coiled tubing members and a pair of clamping portions formed integrally and seamless with the central portion at respective inner ends and extending from the inner ends to respective outer ends;
pressing the outer ends of each clamping body towards the central portion such that each clamping portion extends in an elastically stretched state in a circumferential direction about the tubing members respectively; and
joining the outer ends of each clamping body to the central portion such that the clamping portions remain in the elastically stretched state under tension about the respective tubing members.

27. The method according to claim 26 including joining the outer ends of each clamping body to the central portion of the clamping body by welding.

28. The method according to any one of claims 20 through 27 wherein each clamp assembly comprises at least one clamping body having clamping portions extending about the tubing members respectively and each clamping portion comprises two chamfered end portions at longitudinally opposed ends of the clamping portion in which an inner circumference of the clamping portion is increased towards the end of the clamping portion.

29. The method according to any one of claims 22 to 28 including welding one clamping portion of each clamping assembly to the respective tubing member.

30. The method according to claim 17 including welding only one clamping portion of each clamping assembly to the respective tubing member such that each clamping assembly is welded directly to only one tubing member which is different from the tubing member that each adjacent clamping assembly is welded to in the longitudinal direction of the tubing members.

31. The method according to any one of claims 20 through 30 wherein the tubing members are independent and spaced apart from one another so as to be connected to one another only through the clamp assemblies.
